(19) United States
(12) Patent Application Publication
(10) Pub. No.: US 2025/0310398 A1
(43) Pub. Date: Oct. 2, 2025

(54) COMPUTING DEVICE AND COMMUNICATION METHOD THEREOF

(71) Applicant: LITE-ON TECHNOLOGY CORPORATION, TAIPEI CITY (TW)

(72) Inventor: Yi Tung LIANG, TAIPEI CITY (TW)

(21) Appl. No.: 19/069,384

(22) Filed: Mar. 4, 2025

Related U.S. Application Data
(60) Provisional application No. 63/572,964, filed on Apr. 2, 2024.
(60) Provisional application No. 63/698,105, filed on Sep. 24, 2024.

(51) Int. Cl. H04L 67/101; H04L 41/12; H04W 76/38

(52) U.S. Cl. CPC H04L 67/101; H04L 41/12; H04W 76/38

(57) ABSTRACT

A computing device communicating with network devices through active interfaces is provided. The computing device includes a storage circuitry and a processing circuitry. The storage circuitry is configured to store a protocol database and one or more interface databases. The processing circuitry is configured to preemptively schedule and run a protocol process and interface processes according to a time slice. Each of the interface processes corresponds to one of the active interfaces and one of the interface databases, and is programmed to invoke a callback function in response to a network update event. The callback function is programmed to update the corresponding interface database through a state machine. The protocol process is programmed to determine a network state of the computing device based on data stored in the protocol database and data stored in the interface databases.

### CROSS REFERENCE TO RELATED APPLICATIONS

This application claims the benefit of U.S. Provisional Application No. 63/572,964 filed Apr. 2, 2024, and U.S. Provisional Application No. 63/698,105 filed Sep. 24, 2024, the entirety of which is incorporated by reference herein.

### BACKGROUND OF THE INVENTION

### Field of the Invention

The present invention relates to communication method, and, in particular, to multi-process communication method.

### Description of the Related Art

A communication protocol is a set of rules and conventions that dictate how data is transmitted and received over a network or communication system. It defines the format, timing, sequencing, and error handling of messages exchanged between devices, so that both the sender and receiver can understand and interpret the data correctly. This ensures accurate, reliable, and efficient data transmission between systems.

Traditionally, when a network event associated with the protocol occurs (e.g., receives messages, timer expires), all interfaces are sequentially checked and updated. This approach can introduce significant latency and slower response times, especially in large-scale networks. Additionally, computational resources are wasted, due to the fact that not all interfaces need to be updated for every event.

Therefore, a computing device and communication method thereof that can solve the above problems are needed.

### BRIEF SUMMARY OF THE INVENTION

An embodiment of the present invention provides a computing device. The computing device communicates with one or more network devices through one or more active interfaces. The computing device includes a storage circuitry and a processing circuitry. The storage circuitry is configured to store a protocol database and one or more interface databases. The processing circuitry is configured to preemptively schedule and run a protocol process and one or more interface processes according to a time slice. Each of the interface processes corresponds to one of the active interfaces and one of the interface databases, and is programmed to invoke a callback function in response to a network update event. The callback function is programmed to update the corresponding interface database through a state machine. The protocol process is programmed to determine a network state of the computing device based on data stored in the protocol database and data stored in the interface databases.

An embodiment of the present invention provides a method for a computing device to communicate with one or more network devices through one or more active interfaces. The method is executed by a processing circuitry of the computing device. The method includes preemptively scheduling and running a protocol process and one or more interface processes according to a time slice. A storage circuitry of the computing device is configured to store a protocol database and one or more interface databases. Each of the interface processes corresponds to one of the active interfaces and one of the interface databases, and is programmed to invoke a callback function in response to a network update event. The callback function is programmed to update the corresponding interface database through a state machine. The protocol process is programmed to determine a network state of the computing device based on data stored in the protocol database and data stored in the interface databases.

In one embodiment, the network state of the computing device includes at least one of a routing table, a network topology where the computing device locates and statuses of the active interfaces.

In one embodiment, a sibling of the protocol process forks the interface processes.

In one embodiment, each of the interface databases stores configurations and statuses of the corresponding active interface, wherein the configurations include an identifier of the corresponding active interface.

In one embodiment, each of the interface processes is further programmed to set a timer; and in response to the timer expiring, invoke a timer callback function. The timer callback function is programmed to update the corresponding interface database through the state machine. The network update event includes the timer expiring, and the callback function includes the timer callback function.

In one embodiment, the timer callback function is further programmed to refer to the data stored in the interface database, and make a state transition in the state machine accordingly; perform an action corresponding to the state transition; and update the corresponding interface database.

In one embodiment, the computing device is configured to communicate with the network devices through a network protocol. Each of the interface processes is further programmed to in response to the corresponding active interface receiving a message associated with the network protocol from one of the network devices, invoke a message callback function. The message callback function is programmed to refer to the message and the data stored in the interface database, and make a state transition in the state machine accordingly; perform an action corresponding to the state transition; and update the corresponding interface database. The network update event includes the corresponding active interface receiving the message, and the callback function includes the message callback function.

In one embodiment, the processing circuitry is further configured to in response to one of the active interfaces receiving the message, wake up the corresponding interface process; and in response to running the corresponding interface process, execute the message callback function of the corresponding interface process.

In one embodiment, the network protocol is a spanning tree protocol (STP), and the message is a Protocol Data Unit (PDU).

In one embodiment, the protocol process is further programmed to calculate a spanning tree based on the data stored in the protocol database, so as to determine statues of the active interfaces.

The computing device and communication method provided herein parallelly process network events. More specifically, multi-process technique is applied to govern the transmission and reception of data in the computing device. By assigning a process to each interface, each process can handle its corresponding network event independently, thereby improving the overall network performance.

### BRIEF DESCRIPTION OF THE DRAWINGS

The present disclosure can be more fully understood by reading the subsequent detailed description and examples with references made to the accompanying drawings, wherein:

FIG. 1 shows a system architecture diagram of a computing device, according to an embodiment of the present disclosure;

FIG. 2 illustrates execution of callback functions respectively for the interface processes, the protocol process and other process, according to an embodiment of the present disclosure;

FIG. 3 shows a flow chart of a scheduling method according to an embodiment of the present disclosure;

FIG. 4 is a sequence diagram of a traditional computing device for handling the active interfaces; and

FIG. 5 is a sequence diagram of the computing device for handling the active interfaces, according to an embodiment of the present disclosure.

### DETAILED DESCRIPTION OF THE INVENTION

The following description is made for the purpose of illustrating the general principles of the disclosure and should not be taken in a limiting sense. The scope of the disclosure is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

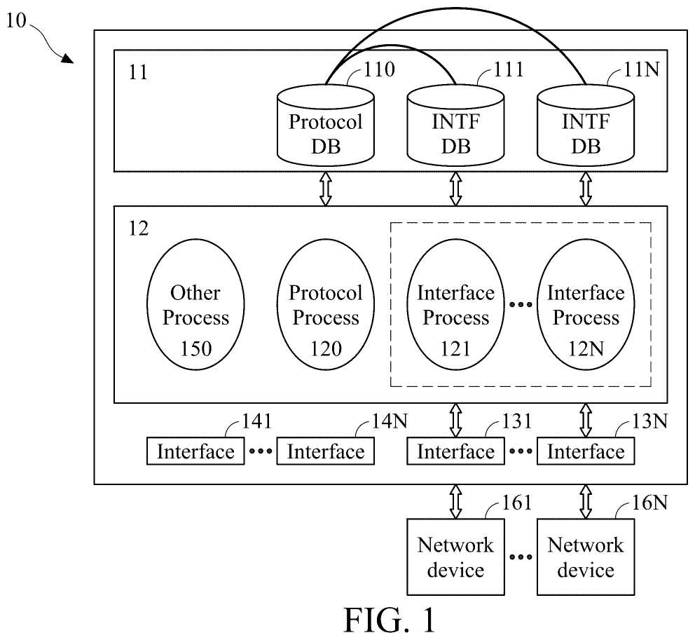

FIG. 1 shows a system architecture diagram of a computing device 10, according to an embodiment of the present disclosure. As shown in FIG. 1, the computing device 10 includes a storage circuitry 11, a processing circuitry 12, active interfaces 131˜13N and inactive interfaces 141˜14N. The computing device 10 communicates with network devices 161˜16N through the active interfaces 131˜13N. The storage circuitry 11 is configured to store a protocol database 110 and interface databases 111˜11N.

The computing device 10 can be any computer with computing capabilities, such as a personal computer (e.g., desktop computer or notebook computer), a server computer, a mobile device (e.g., tablet computer or smart phone), or a network device (e.g., switch or router), but the present disclosure is not limited thereto.

The processing circuitry 12 may include any one or more general-purpose or special-purpose processors and combinations thereof for executing instructions, such as a central processing unit (CPU) and/or a graphics processing unit (GPU). The processing circuitry 12 may also include volatile memories such as dynamic random-access memory (DRAM) and/or static random-access memory (SRAM), but the present disclosure is not limited thereto.

The storage circuitry 11 may include a hard disk (HDD), a solid-state drive (SSD), an optical disk, or any other type of memory that contains non-volatile memory (e.g., read-only memory, electrically-erasable programmable read-only memory (EEPROM), flash memory, and non-volatile random-access memory (NVRAM)), but the disclosure is not limited thereto.

Each of the active interfaces 131˜13N and the inactive interfaces 141˜14N may be physical or logical. For example, the interface may be an Ethernet network interface card (NIC), Wi-Fi adapter, USB network adapter, etc. For another example, the interface may be a VLAN interface, virtual machine interface, docker container network interface, but the disclosure is not limited thereto.

In one embodiment, the processing circuitry 12 can execute a communication method. The communication method includes preemptively schedule and run a protocol process 120, interface processes 121˜12N and other processes 150 according to a time slice. By executing the communication method, the computing device 10 can communicate with the network devices 161˜16N through the active interfaces 131˜13N.

Each of the protocol process 120, interface processes 121˜12N and other processes 150 may be a normal process or lightweight process (i.e., thread). In one implementation, a normal process may be generated by ‘fork( )’ function in Linux system or by ‘CreateProcess( )’ function in Windows system. In another implementation, a thread may be generated by ‘pthread_create( )’ function in Linux system or by ‘CreateThread( )’ function in Windows system.

In one embodiment, each of the protocol process 120, interface processes 121˜12N and other processes 150 is a normal process and has its own memory space and resources. This provides isolation and stability but can be more resource-intensive. In one implementation, the protocol process 120 manages overall topology operations by initializing global resources, creating port tasks, handling global events, and cleaning up resources, while the interface processes 121˜12N focuses on managing specific port or interface events by initializing interface resources, handling port-specific events, and performing resource cleanup, ensuring smooth operation of the topology protocol at both global and port-specific levels.

Each of the protocol database 110 and the interface databases 111˜11N may be implemented using a database system, e.g., MySQL, MariaDB, SQLite, etc. Alternatively, each of the protocol database 110 and the interface databases 111˜11N may be implemented using a file system, e.g., a JSON, CSV, XML file, etc. Alternatively, the protocol database 110 and the interface databases 111˜11N may be implemented using a combination of database systems and file systems.

In one embodiment, the protocol database 110 is a structured collection of configuration and operational data that is initialized and managed through various setup functions of the protocol process 120, ensuring that all necessary parameters for the protocol are properly established and maintained, and later cleared by specific functions of the protocol process 120 to reset the data as needed, thereby ensuring the protocol operates smoothly and efficiently. On the other hand, the interface databases 111˜11N are responsible for managing and storing data specific to each port or interface, ensuring that the necessary information, such as interface state information, for each port's operation is readily available and can be accessed or modified as needed during the initialization, event handling, and cleanup processes. These interface databases can support the respective interface process by maintaining the state and configuration of each port, allowing the interface processes 121˜12N to handle port-specific events and operations efficiently.

Each of the interface processes 121˜12N corresponds to a respective one of the active interfaces 131˜13N. Similarly, each of the interface processes 121-12N corresponds to a respective one of the interface databases 111˜11N. Moreover, each of the interface processes 121˜12N is programmed to invoke a callback function in response to a network update event. The callback function is programmed to update the corresponding interface database through a state machine.

In one embodiment, the callback functions in the interface process 121˜12N are responsible for handling specific events related to each port, such as when a timer expires or a message is received. These functions are part of a state machine, which means they manage the port's state transitions and execute actions based on the current state and the events they receive. This ensures that each port responds appropriately to events, maintaining smooth and efficient operation by transitioning through different states as needed.

The protocol process 120 is programmed to determine a network state of the computing device 10 based on data stored in the protocol database 110 and data stored in the interface databases 111˜11N. In one embodiment, the data stored in the protocol database 110 includes a union set of data stored in the interface databases 111˜11N. In other words, there may be a synchronization mechanism between the protocol database 110 and the interface databases 111˜11N to ensure data consistency.

In one embodiment, the interface database may store a status of an active interface while the protocol database may store statuses of all active interfaces. The synchronization mechanism between the protocol database 110 and the interface databases 111˜11N ensures that the status of the active interface stored in the protocol database 110 and that stored in the interface databases 111˜11N are consistent and up-to-date.

The network update event may include but not limited to a link-status change, an address change, traffic received and transmitted, error detection, etc. In one embodiment, the network update event involves an expiration of a timer. The corresponding callback function involves a timer callback function. In another embodiment, the network update event involves the reception of specific messages. The corresponding callback function involves a message callback function.

In one embodiment, the interface process 121˜12N can process network update events such as message events (handling incoming messages or commands related to the port), timer expiry events (handling tasks related to timer expiry, such as updating port states or triggering periodic actions), and terminate events (signaling the child interface process 121˜12N to terminate).

The network state may refer to the network condition or configuration at any given moment. In one embodiment, the network state may be a routing table, a network topology or statuses of the active interfaces 131˜13N. For example, the network state may be a routing table for a routing protocol (e.g., Open Shortest Path First (OSPF)). The data stored in the protocol database may include a network topology. The protocol process 120 may use this network topology to update a route in the routing table. For another example, the network state may be statuses of the active interfaces 131˜13N for Spanning Tree Protocol (STP). The protocol process 120 may use the network topology stored in the protocol database to calculate a spanning tree, and then set the status of the active interface to one of ‘Forwarding’, ‘Blocking’, ‘Learning’, ‘Listening’ and ‘Disabled’ according to the spanning tree. In another embodiment, the network state may be network topology, link status, traffic load, device availability, but the disclosure is not limited thereto.

In one embodiment, the protocol process 120 can manage the overall state of the network, handle events related to the network topology, and ensure efficient data transmission. This can include processing PDU (Protocol Data Unit) messages, such as Bridge Protocol Data Unit (BPDU) messages for second layer applications, and updating the internal network state of the protocol.

It should be noted that the processing circuitry 12 preemptively schedule and run the protocol process 110, interface processes 111˜11N and other processes 150 according to a time slice. A time slice refers to a fixed, predefined time period allocated to each process during which the process is allowed to execute. In other words, the processing circuitry 12 adopts a round-robin scheduling algorithm to schedule these processes. Therefore, all processes are treated equally with a fixed time slice. Once the time slice of a process expires, the processing circuitry 12 runs the next process in the ready queue.

In one embodiment, the processing circuitry 12 is further configured to wake up the corresponding interface process when an active interface receives the message and execute the message callback function of the corresponding interface process when running the corresponding interface process. Specifically, due to the event-triggered design, after the interface process registers the callback function (e.g., message callback function), the processing circuitry may place the interface process in a waiting queue, putting the interface process in a waiting/blocked state. Once the corresponding event occurs (e.g., message reception), the processing circuitry may wake up the blocked interface process and move it back to the ready queue. When running this interface process, the processing circuitry start its execution from the registered callback function (e.g., message callback function).

In one embodiment, the interface processes 121˜12N are forked by a sibling of the protocol process 120. In one implementation, a main process forks the protocol process 120 and a management process, which becomes a sibling of the protocol process 120. Then, the management process forks the interface processes 121˜12N. Notably, this design ensures that the protocol process 120 and the interface processes 121˜12N can operate independently. That is, the protocol process 120 will not be affected if the management process or the interface processes are terminated. Similarly, the management process or the interface processes will not be affected if the protocol process 120 is terminated.

In another embodiment, the protocol process 120 starts by initializing the global state and various resources, such as semaphores, memory pools, message queues, and timers. The protocol process 120 then identifies the first interface process 121 by iterating through the ports and checking if each port is administered. For each administered port, the protocol process 120 forks a new child interface process 121˜12N. This is done by creating a new process and assigning the port entry to the child process if it is the child. The child interface process 121˜12N then replaces its current image with a new program image, where it initializes resources like semaphores, memory pools, message queues, and timers. The child interface process 121˜12N enters an event handling loop where it waits for events. The child process will de-initialize these system resources only after receiving a terminate event from the parent protocol process 120. After processing the terminate event from the protocol process 120, the child interface process 121˜12N deinitializes the resources by stopping timers, message queues, releasing memory pools, and deleting semaphores. Meanwhile, the protocol process 120 continues to handle high-level protocol events. These can include PDU events (handling incoming PDU packets), management messages (handling management messages), and timer expiry events (handling timer expiry events). Upon receiving a terminate event (signaling the protocol process to terminate), the protocol process 120 sets its running state to false, sends a terminate event to the child interface process 121˜12N, waits for the child interface processes 121˜12N to terminate, and then deinitializes the resources by stopping timers, message queues, releasing memory pools, and deleting semaphores. In summary, the protocol process 120 manages the overall state and high-level protocol events, while the child interface processes 121˜12N handle specific port-related and interface-related tasks. Both the protocol process and child interface processes work together to manage the topology operations effectively.

In one embodiment, the interface database stores configurations and statuses of the corresponding active interface. The configurations include an identifier of the corresponding active interface. In one embodiment, the configurations may also include address (e.g., MAC address and IP address), description, etc. In one embodiment, the statuses may include ‘Up’, ‘Down’, ‘Disabled’, ‘Test’, etc. In another embodiment, the statuses may include ‘Forwarding’, ‘Blocking’, ‘Learning’, ‘Listening’, but the disclosure is not limited thereto.

In one embodiment, the callback function is further programmed to refer to the data stored in the interface database, and make a state transition in the state machine accordingly. Then, the callback function performs an action corresponding to the state transition and updates the corresponding interface database. The state machine defines the processing logic toward the referred data. Accordingly, the callback function can dynamically adapt to network changes and ensure the corresponding interface database to maintain accurate and up-to-date information.

In one embodiment, each of the interface processes 121˜12N is further programmed to set a timer, and invoke a timer callback function in response to the timer expiring. The timer callback function is programmed to update the corresponding interface database through the state machine. In this case, the network update event involves the timer expiring and the callback function involves the timer callback function. Typically, a timer is set for a periodical task. For example, the timer may be set for the interface process to periodically exchange information with the neighbor devices. Once the timer expires, the interface process sends and receives the exchanged information and makes a further processing during the transitions in the state machine. Then, the processing result is stored into the corresponding interface database.

Traditionally, the timer callback function for each interface is handled sequentially inside a timer callback function of the protocol process. However, in this disclosure, the timer callback functions of the interface processes are independent of each other. Therefore, the timer callback functions of the interface processes can be invoked respectively and timely.

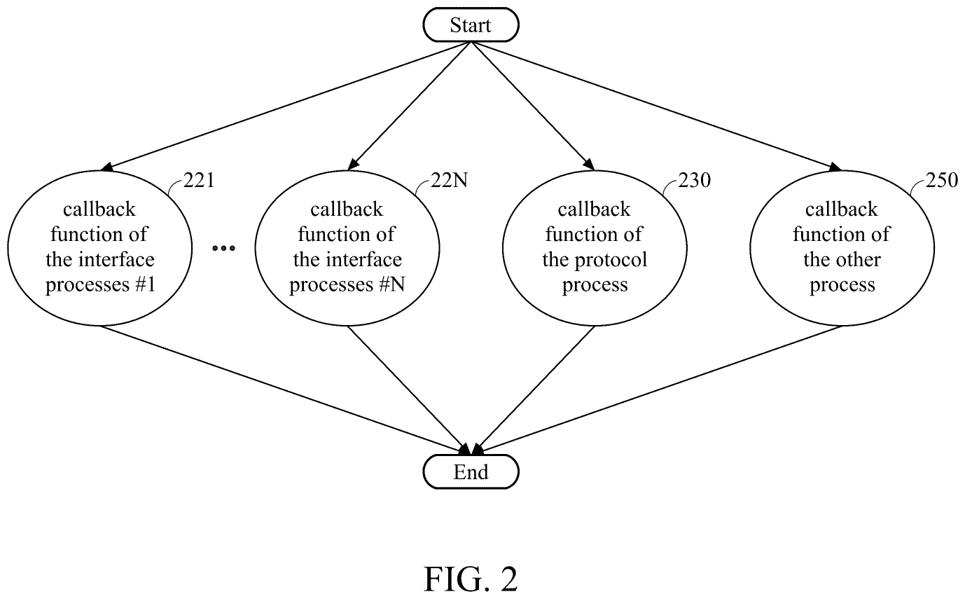

FIG. 2 illustrates execution of callback functions 221˜22N, 230 and 250, respectively, for interface processes 1˜N, the protocol process and other process, according to an embodiment of the present disclosure. For ease of explanation, the following considers the interface processes 121˜12N, the protocol process 120 and the other process 150, as the aforementioned interface processes 1˜N, protocol process and other process. In this embodiment, the protocol process 120 and other process 150 are also programmed to register their respective timer callback function. As shown in FIG. 2, the timer callback functions of the interface processes 121˜12N, the protocol process 120 and other process 150 are separated, allowing each timer callback function to be invoked and executed independently. Therefore, the timer callback function of the interface processes 121 will not cause a delay to that of the interface processes 122, for example. Similarly, the timer callback function of the interface processes 121 will not cause a delay to that of the protocol process 120. This ensures that the timer callback function of the protocol process 120 can terminate earlier than the traditional method.

In one embodiment, the computing device 10 is configured to communicate with the network devices through a network protocol, e.g., spanning tree protocol (STP) or any routing protocol (e.g., OSPF). In this embodiment, each of the interface processes 121˜12N is further programmed to invoke a message callback function in response to the corresponding active interface receiving a message associated with the network protocol from one of the network devices. The message callback function is programmed to refer to the message and the data stored in the interface database, and make a state transition in the state machine accordingly. Then, the message callback function performs an action corresponding to the state transition, and updates the corresponding interface database. In this case, the network update event involves the corresponding active interface receiving the message and the callback function involves the message callback function.

In one embodiment, the network protocol is Open Shortest Path First (OSPF), and the message is a Link State Advertisement (LSA). OSPF is a common layer 3 protocol. LSA is used for the computing device 10 and the network devices to exchange information about the state and cost of their connected links. The information in the LSA may be further processed and stored into corresponding interface database during the execution of the message callback function.

In one embodiment, the protocol process 120 is further programmed to calculate shortest paths to each destination based on the data stored in the protocol database 110, so as to determine the routing table of the computing device 10. The protocol database 110 includes a union set of data stored in the interface databases 111˜11N. In other words, the protocol database 110 stores information about the state and cost of every link in the network. Therefore, the protocol process 120 can calculate shortest paths to each destination based on these states and costs stored in the protocol database 110.

In one embodiment, the network protocol is a spanning tree protocol (STP), and the message is a Bridge Protocol Data Unit (BPDU). STP is a common layer 2 protocol. BPDU is used for the computing device 10 and the network devices to maintain and update the topology of a network. It helps in determining the optimal path for data transmission while avoiding network loops. Generally, spanning tree protocol is implemented using a state machine. The state machine operates based on a set of defined states (e.g., ‘PORT RECEIVE’, ‘PORT INFORMATION’, ‘PORT ROLE SELECTION’ and ‘PORT TRANSMIT’) and transitions, driven by events such as receiving BPDUs, topology changes, and timer expirations.

More specifically, the ‘PORT RECEIVE’ state can operate to both receive the message and handle the received message, such as validating it. When a port is in the ‘PORT RECEIVE’ state, it can not only receive the BPDU (Bridge Protocol Data Unit) but also perform necessary actions to validate the received BPDU. This includes checking the integrity and relevance of the BPDU to ensure it is a valid message that can be processed further by the state machine.

In this embodiment, once receiving a BPDU, the interface process invokes its message callback function to make a state transition in the state machine according to the received BPDU and the data stored in the interface database (e.g., several flags). Then, the message callback function is executed to perform an action (e.g., set flags) corresponding to the state transition, and update its interface database (e.g., store processing results of the received BPDU).

Specifically, a sequence of state transitions may be made. For example, the initial state of the state machine starts with the ‘PORT RECEIVE’ state. The ‘PORT RECEIVE’ state validates the received BPDU and marks a flag ‘rcvdBpdu’ if the received BPDU is valid. Once the flag ‘rcvdBpdu’ is marked, the ‘PORT INFORMATION’ state processes the received BPDU to determine whether to update spanning tree information. If the spanning tree information is updated, the ‘PORT INFORMATION’ state sets a flag ‘updateInfo’. The flag ‘updateInfo’ triggers the ‘PORT ROLE SELECTION’ state to re-evaluate port roles. If a port role changes, the ‘PORT TRANSMIT’ state constructs and sends a new BPDU to notify neighboring devices (i.e., the network devices 161˜16N). It should be noted that the transitions between these states are conditional, and not all states are executed for every BPDU.

More specifically, the interface process 121˜12N can execute these finite state machines as defined in the standard/specifications. For example, in the context of spanning tree protocol, the state machine can operate based on receiving events of BPDU event from the active interfaces 131˜13N. In such scenario, if the interface process 121˜12N have to be tied to the protocol process 120, it would result in blocking each other.

In another embodiment, the network protocol is Open Shortest Path First (OSPF), and the protocol process 120 is programmed to handle protocol messages such as Link State Advertisements (LSAs). OSPF is a common layer 3 protocol. LSAs are used by the computing device 10 and the network devices to exchange information about the state and cost of their connected links. The information in the LSAs may be further processed and stored in the corresponding protocol database during the execution of the message callback function. While the OSPF protocol handles LSAs, the reception of packets is executed by the interface process 121˜12N, which then wakes up the protocol process 120 to handle them. The reception of packets by the interface process 121˜12N includes tasks like reading the incoming data from the active interfaces 131˜13N and performing any necessary preliminary processing. After the interface process 121˜12N receives the packets, it wakes up the protocol process 120 to handle the higher-level protocol logic, such as validating the LSAs, updating the protocol database, and making routing decisions. As for sending packets, there are two categories: LSA updates are initiated by the protocol process 120, while other packets (such as periodic and topology-related packets) are handled by the interface process 131˜13N. Preferably, the tasks conventionally managed entirely by the protocol process 120 are now divided, with the interface process 121˜12N handling tasks it can manage. This design ensures that the protocol process is not overwhelmed with low-level tasks and can efficiently manage the overall protocol operations

In one embodiment, the protocol process 120 can handle message received in the ‘PORT RECEIVE’ state. the protocol process 120 can validate the received BPDU and marks a flag rcvdBpdu if the BPDU is valid. The protocol process 120 can also trigger the ‘PORT TRANSMIT’ state, constructing and sending a new BPDU to notify neighboring devices (i.e., the network devices 161˜16N) when a port role changes. On the other hand, the child interface processes 121˜12N can handle the ‘PORT ROLE SELECTION’ state, re-evaluating port roles based on the updated spanning tree information. The child interface processes 121˜12N do not handle BPDUs received in the ‘PORT RECEIVE’ state, which is handled by the protocol process.

In one implementation, a sequence of state transitions may be made by the protocol process 120. For example, the initial state of the state machine starts with the ‘PORT RECEIVE’ state handled by the protocol process. The protocol process 120 can handle the receipt of BPDUs and processes them to determine whether to update spanning tree information. If the received BPDU is valid, the protocol process 120 can update the spanning tree information and trigger the interface process 121˜12N to handle the ‘PORT INFORMATION’ state, where it processes the updated spanning tree information. The interface process 121˜12N then handles the ‘PORT ROLE SELECTION’ state to re-evaluate port roles based on the updated spanning tree information. More specifically, the protocol process 120 can handle the ‘PORT RECEIVE’ state, which validates the received BPDU. Once the received BPDU is valid, the interface process 121˜12N can handle the ‘PORT INFORMATION’ state, processing the received BPDU to determine whether to update spanning tree information. If the spanning tree information is updated, the ‘PORT INFORMATION’ state sets a flag updateInfo. This flag triggers the interface process 121˜12N to handle the ‘PORT ROLE SELECTION’ state, re-evaluating port roles based on the updated spanning tree information. If a port role changes, the protocol process 120 handles the ‘PORT TRANSMIT’ state, constructing and sending a new BPDU to notify neighboring devices (i.e., the network devices 161˜16N). It should be noted that the transitions between these states are conditional, and not all states are executed for every BPDU.

In one embodiment, the protocol process 120 is further programmed to calculate a spanning tree based on the data stored in the protocol database 110, so as to determine statues of the active interfaces 131˜13N. As mentioned above, the protocol database 110 comprises a union set of data stored in the interface databases 111˜11N. By collecting data from the interface databases 111˜11N, the protocol process 120 may obtain a complete topology of the network where the computing device locates. Then, the protocol process 120 may calculate a spanning tree according to the obtained network topology. Based on the calculated spanning tree, the protocol process 120 may further update the statuses of the active interfaces 131˜13N stored in the interface databases 111˜11N. For example, the protocol process 120 may set the status of the active interface from ‘Listening’ to ‘Learning’. For another example, the protocol process 120 may set the status of the active interface from ‘Blocking’ to ‘Forwarding’.

In another embodiment, the protocol database 110 comprises a combined set of data collected from the individual interface databases 111˜11N, maintaining consistent and up-to-date information about the state and configuration of each port or interface. By collecting and unifying data from the interface databases 111˜11N, for example, the protocol process 120 may set the status of an active interface from ‘Listening’ to ‘Learning’. In another example, the protocol process 120 may set the status of an active interface from ‘Blocking’ to ‘Forwarding’.

In one embodiment, the union set of data can be a state of the interface, which is also stored in the interface databases 111˜11N. This allows for synchronization between the protocol database 110 and interface databases 111˜11N, ensuring that both have consistent and up-to-date information about the state and configuration of each port or interface.

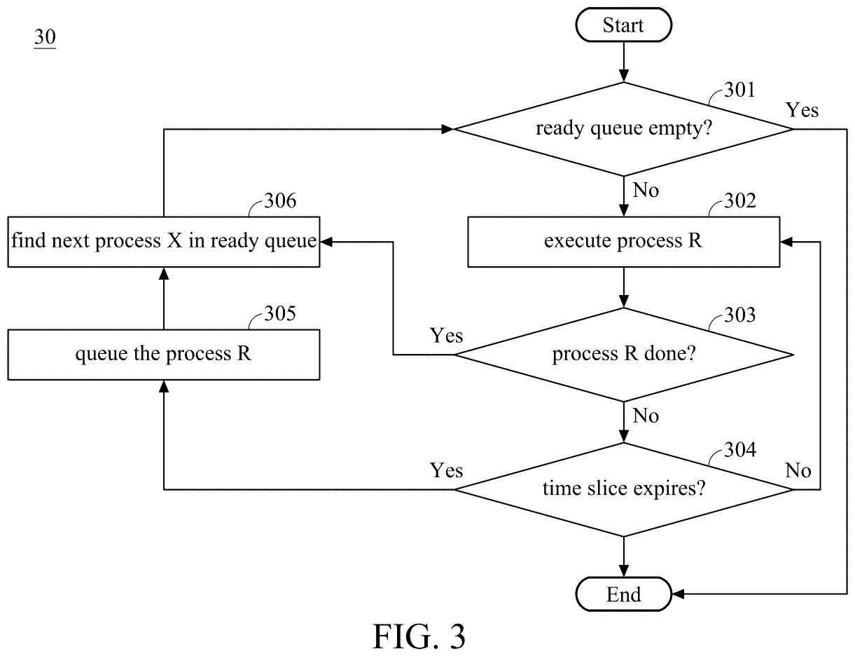

FIG. 3 shows a flow chart of a scheduling method 30 according to an embodiment of the present disclosure. The scheduling method 30 illustrates details about the operation of preemptively schedule and run the protocol process 120, interface processes 121˜12N and other processes 150 according to the time slice in the abovementioned communication method. As shown in FIG. 3, the method 30 includes steps 301˜306. The following explains steps 301˜306.

In step 301, the processing circuitry 12 checks whether its ready queue is empty. If the ready queue is empty, the method 30 terminates. If the ready queue is not empty, proceed to step 302.

In step 302, the processing circuitry 12 dequeues and runs the first process, namely R, from the ready queue. Specifically, the processing circuitry 12 set a timer to a predefined time slice for the running process R. The timer begins counting down as soon as execution of process R starts. It should be noted that the timer here is a hardware timer, which is totally different from the software timers set by the interface processes. It should be noted that the first process R can be any type of process. The process R can be a protocol process, an interface process, or other process. In other words, the disclosure does not limit the queueing order of protocol processes, interface processes, and other processes inside the ready queue. In addition, the disclosure does not limit the execution order of protocol processes, interface processes, and other processes.

In step 303, the processing circuitry 12 checks whether the running process R has completed. If the running process R has completed, proceed to step 306. If the running process R has not completed, proceed to step 304. In step 304, the processing circuitry 12 check whether the time slice has expired. If the time slice has expired, proceed to step 305. If the time slice has not expired, return to step 302 to continue executing process R.

In step 305, the processing circuitry 12 queues the process R. Mostly, the processing circuitry 12 places the process R back into the ready queue. However, in some situation, the processing circuitry 12 places the process R into other queue. For example, the processing circuitry 12 may place the process R into the waiting queue if the process R is waiting for an event (e.g., I/O operation). In step 306, the processing circuitry 12 selects the next process, X, from the ready queue and repeats the aforementioned steps for process X.

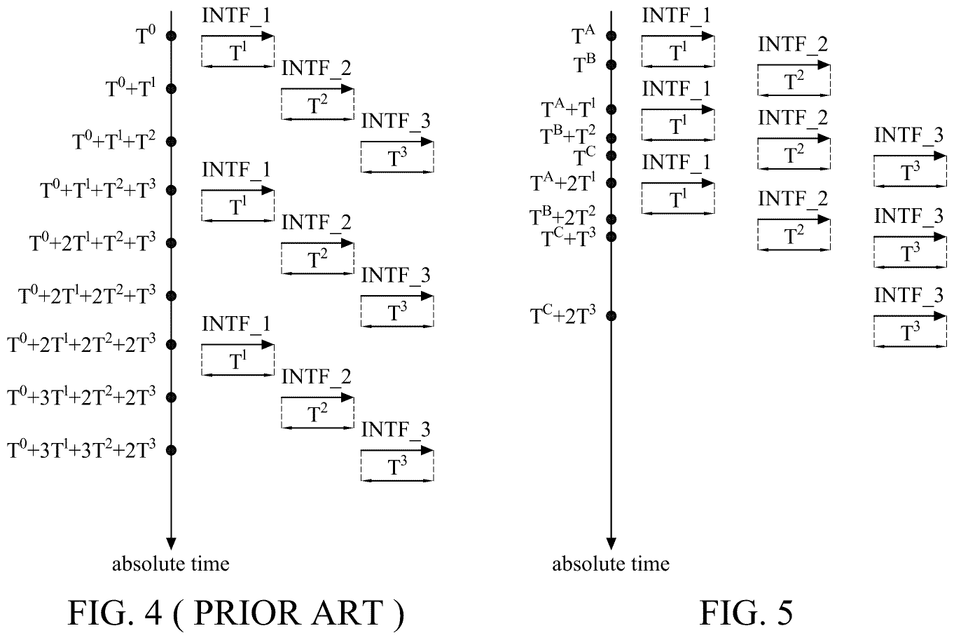

FIG. 4 is a sequence diagram of a traditional computing device for handling active interfaces INTF_1˜INTF_3. In this example, the traditional computing device handles the active interfaces INTF_1˜INTF_3 sequentially in one process.

FIG. 5 is a sequence diagram of the computing device 10 for handling the active interfaces INTF_1˜INTF_3, according to an embodiment of the present disclosure. In the example illustrated in FIG. 5, the active interfaces INTF_1˜INTF_3 respectively correspond to the active interfaces 131˜133 in FIG. 1, and the computing device 10 handles the active interfaces INTF_1˜INTF_3 parallelly using the interface processes 121˜123.

In the following, FIG. 4 is discussed with FIG. 5 to compare the performance of the traditional computing device and the computing device 10.

Although three handled active interfaces are respectively drawn in FIGS. 4 and 5, it should be noted that it is merely for simplicity and convenience of illustration, and the present disclosure does not limit the number of the handled active interfaces and the number of the used interface processes. In various embodiments, the number of the handled active interfaces and the number of the used interface processes can be arbitrary, such as 10 or more. 10 or more).

Traditionally, the active interfaces are handled sequentially in a for-loop. As shown in FIG. 4, the traditional computing device must handle the active interfaces INTF_1˜INTF_3 in order. Even if no event occurs on a specific active interface, the traditional computing device still has to spend at least one cycle time on this specific active interfaces. Over the long term, this will waste a significant amount of time and computational resources.

Formula 1 shows the computation time of the nth execution for a specific active interface. T⁰ represents the start time of the first execution for the active interface INTF_1. Tⁱ represents the computation time of an execution for the active interface i. T^{j} represents the computation time of an execution for the active interface j. n represents the execution count.

$${T}^{0} + ( n - 1 ) {\sum }_{i = 1}^{N} {T}^{i} + {\sum }_{j = 1}^{i - 1} {T}^{j} \qquad Formula 1$$

As shown in FIG. 4, Tⁱ and T^{j} for the active interface INTF_1 are both T¹. Tⁱ and T^{j} for the active interface INTF_2 are both T². Therefore, the computation time of the 1st execution (n=1) for active interface INTF_2 is T⁰+T¹. The computation time of the 2nd execution (n=2) for active interface INTF_2 is T⁰+2T¹+T²+T³.

In embodiments of the present disclosure, the computing device 10 handles the active interfaces INTF_1˜INTF_3 parallelly using the interface processes 121˜123. In other words, the interface processes can independently manage their respective active interfaces. As shown in FIG. 5, an execution for an active interface can start at any time without the interference of other interface processes. For example, the execution for the active interface INTF_1 starts at time T^{A}, the execution for the active interface INTF_2 starts at time T^{B}, and the execution for the active interface INTF_3 starts at time T^{C}. Since there is no dependency between time T^{A}, T^{B} and T^{C}, each active interface can be handled independently. Moreover, with the event-triggered design, not all active interfaces need to be handled. Only active interfaces where events occur need to be handled.

Formula 2 shows the computation time of the nth execution for a specific active interface. T^{FirstRunAbsTime} represents the start time of the first execution for the specific active interface. T^{IntfExeTime} represents the computation time of an execution for the specific active interface. n represents the execution count.

$${T}^{FirstRunAbsTime} + ( n - 1 ) {T}^{IntfExeTime} \qquad Formula 2$$

As shown in FIG. 5, T^{FirstRunAbsTime} for the active interface INTF_1 is T^{A}. T^{IntfExeTime} for the active interface INTF_1 is T¹. Therefore, the computation time of the 3rd (n=3) execution for the active interface INTF_1 is T^{A}+2 T¹. Similarly, T^{FirstRunAbsTime} for the active interface INTF_2 is T^{B} as shown in FIG. 5. T^{IntfExeTime} for the active interface INTF_2 is T². Therefore, the computation time of the 2nd (n=2) execution for the active interface INTF_2 is TB+T².

Regarding the computation time of the 2nd (n=2) execution for the active interface INTF_2, it takes time T¹+T²+ . . . +T^{N} for the traditional computing device to start the 2nd execution. However, it only takes time T² for the computing device 10. On the premise that the two computing devices both apply the round-robin scheduling algorithm, this comparison can show that the computation efficiency is notably improved in the computing device 10.

The computing device and communication method provided herein parallelly process network events. More specifically, multi-process technique is applied to govern the transmission and reception of data in the computing device. By assigning a process to each interface, each process can handle its network event independently, thereby improving the overall network performance.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. A computing device, communicating with one or more network devices through one or more active interfaces, comprising:
a storage circuitry, configured to store a protocol database and one or more interface databases; and
a processing circuitry, configured to:
preemptively schedule and run a protocol process and one or more interface processes according to a time slice;
wherein each of the interface processes corresponds to one of the active interfaces and one of the interface databases, and is programmed to invoke a callback function in response to a network update event, wherein the callback function is programmed to update the corresponding interface database through a state machine; and
wherein the protocol process is programmed to determine a network state of the computing device based on data stored in the protocol database and data stored in the interface databases.

2. The computing device as claimed in claim 1, wherein the network state of the computing device comprises at least one of a routing table, a network topology where the computing device locates and statuses of the active interfaces.

3. The computing device as claimed in claim 1, wherein a sibling of the protocol process is programmed to fork the interface processes.

4. The computing device as claimed in claim 1, wherein each of the interface databases stores configurations and statuses of the corresponding active interface, wherein the configurations include an identifier of the corresponding active interface.

5. The computing device as claimed in claim 1, wherein each of the interface processes is further programmed to:
set a timer; and
in response to the timer expiring, invoke a timer callback function;
wherein the timer callback function is programmed to update the corresponding interface database through the state machine;
wherein the network update event includes the timer expiring, and the callback function includes the timer callback function.

6. The computing device as claimed in claim 5, wherein the timer callback function is further programmed to:
refer to the data stored in the interface database, and make a state transition in the state machine accordingly;
perform an action corresponding to the state transition; and
update the corresponding interface database.

7. The computing device as claimed in claim 1, wherein the computing device is configured to communicate with the network devices through a network protocol, wherein each of the interface processes is further programmed to:
in response to the corresponding active interface receiving a message associated with the network protocol from one of the network devices, invoke a message callback function, wherein the message callback function is programmed to:
refer to the message and the data stored in the interface database, and make a state transition in the state machine accordingly;
perform an action corresponding to the state transition; and
update the corresponding interface database;
wherein the network update event includes the corresponding active interface receiving the message, and the callback function includes the message callback function.

8. The computing device as claimed in claim 7, wherein the processing circuitry is further configured to:
in response to one of the active interfaces receiving the message, wake up the corresponding interface process; and
in response to running the corresponding interface process, execute the message callback function of the corresponding interface process.

9. The computing device as claimed in claim 7, wherein the network protocol is a spanning tree protocol (STP), and the message is a Protocol Data Unit (PDU).

10. The computing device as claimed in claim 9, wherein the protocol process is further programmed to:
calculate a spanning tree based on the data stored in the protocol database, so as to determine statues of the active interfaces.

11. A method for a computing device to communicate with one or more network devices through one or more active interfaces, executed by a processing circuitry of the computing device, the method comprising:
preemptively scheduling and running a protocol process and one or more interface processes according to a time slice;
wherein a storage circuitry of the computing device is configured to store a protocol database and one or more interface databases;
wherein each of the interface processes corresponds to one of the active interfaces and one of the interface databases, and is programmed to invoke a callback function in response to a network update event, wherein the callback function is programmed to update the corresponding interface database through a state machine; and
wherein the protocol process is programmed to determine a network state of the computing device based on data stored in the protocol database, and data stored in the interface databases.

12. The method as claimed in claim 11, wherein the network state of the computing device comprises at least one of a routing table, a network topology where the computing device locates and statuses of the active interfaces.

13. The method as claimed in claim 11, wherein a sibling of the protocol process forks the interface processes.

14. The method as claimed in claim 11, wherein each of the interface databases stores configurations and statuses of the corresponding active interface, wherein the configurations include an identifier of the corresponding active interface.

15. The method as claimed in claim 11, wherein each of the interface processes is further programmed to:
set a timer; and
in response to the timer expiring, invoke a timer callback function;
wherein the timer callback function is programmed to update the corresponding interface database through the state machine;
wherein the network update event includes the timer expiring, and the callback function includes the timer callback function.

16. The method as claimed in claim 11, wherein the timer callback function is further programmed to:
refer to the data stored in the interface database, and make a state transition in the state machine accordingly;
perform an action corresponding to the state transition; and
update the corresponding interface database.

17. The method as claimed in claim 11, wherein the computing device is configured to communicate with the network devices through a network protocol, wherein each of the interface processes is further programmed to:
in response to the corresponding active interface receiving a message associated with the network protocol from one of the network devices, invoke a message callback function, wherein the message callback function is programmed to:
refer to the message and the data stored in the interface database, and make a state transition in the state machine accordingly;
perform an action corresponding to the state transition; and
update the corresponding interface database;
wherein the network update event includes the corresponding active interface receiving the message, and the callback function includes the message callback function.

18. The method as claimed in claim 11, further comprises:
in response to one of the active interfaces receiving the message, wake up the corresponding interface process; and
in response to running the corresponding interface process, execute the message callback function of the corresponding interface process.

19. The method as claimed in claim 17, wherein the network protocol is a spanning tree protocol (STP), and the message is a Protocol Data Unit (PDU).

20. The method as claimed in claim 19, wherein the protocol process is further programmed to:
calculate a spanning tree based on the data stored in the protocol database, so as to determine statues of the active interfaces.
